(19) United States
(12) Patent Application Publication
(10) Pub. No.: US 2003/0050014 A1
(43) Pub. Date: Mar. 13, 2003

(54) Measurement of wideband signals

(76) Inventors: Peter John Cain, Lasswade (GB); Roy Blair MacNaughton, Edinburgh (GB); James Wayne Cunningham, Windsor, CA (US); Alistair Campbell Mill, Edinburgh (GB)

Correspondence Address: LOWE HAUPTMAN GILMAN & BERNER, LLP, Suite 310, 1700 Diagonal Road, Alexandria, VA, 22314, US

(21) Appl. No.: 09/948,859

(22) Filed: Sep. 10, 2001

(51) Int. Cl. H04B 17/00

(52) U.S. Cl. 455/67.1; 455/226.1

(57) ABSTRACT

An analyser and associated method for analysing a multi-channel radio frequency (RF) signal comprising, a down-converter for deriving an intermediate frequency (IF) signal corresponding to an RF signal to be measured; a measurement filter for filtering out all but a portion of the IF signal which includes signals from a desired channel to be measured and some of a neighbouring channel; a trigger filter responsive to the same IF signal and having a pass band narrower than and inside the pass band of said measurement filter and processing means for measuring and indicating parameters of the signal filtered by the measurement filter in response to a trigger signal filtered by the trigger filter.

This invention relates to modulation analysis of frequency-agile RF signals and more specifically to adapting a conventional RF signal analyser to modulation analysis of wideband multi-channel signals such as frequency hopped signals.

Frequency hopping is used by many standards such as Bluetooth, a wireless standard that allows devices to “talk” to each other over short distances. In such a system the frequency at which the devices communicate changes many times a second in a pseudo-random fashion between a number of possible channels. This brings advantages in privacy and noise immunity, but presents some difficulty in analysing the signal with known test and measurement equipment. Dedicated Bluetooth receiver devices can track the changes in the frequency for the purpose of communication, but manufacturers of the devices require test equipment capable of analysing the signals in greater depth, for example to their frequency and modulation characteristics for compliance with the standards.

Conventional spectrum analyser equipment exists for making such an analysis in static-frequency radio formats. However, conventional spectrum analysers cannot track the frequency changes fast enough in the way dedicated devices can. In view of this, when measuring RPF frequency hopped signals, a common technique is for the analyser to be fixed on one channel to be measured (zero span) and looking at this spot frequency instead of the entire spectrum. Then the analyser waits until the measured signal hops to that channel. The measurement is triggered by monitoring the “video” output of the analyser, which tracks the RF power level as it changes over time.

In systems such as Bluetooth (or GSM), where the neighbouring channels are close together, the measurement bandwidth required for analysis includes much of the neighbouring channel also. Since the bandwidth of the trigger circuit is the same as the measurement bandwidth in a conventional analyser, false triggers and misleading analyses will result, because it is not practicable to predict what the level of the wanted and unwanted signals are accurately enough to discriminate them.

According to a first aspect of the invention there is provided an analyser for analysing a multi-channel radio frequency (RF) signal wherein said analyser comprises:

a down-converter for deriving an intermediate frequency (IF) signal corresponding to an RF signal to be measured;

a first filter for filtering out all but a portion of the IF signal, said portion including signals from a desired channel to be measured and at least a portion of a neighbouring channel;

a second filter also responsive to the same IF signal and having a pass band narrower than and inside the pass band of said first filter;

processing means for measuring and indicating parameters of the signal filtered by first filter in response to a trigger signal filtered by said second filter.

By this means, and with only a simple modification of a commercial analyser, the necessary measurement bandwidth can be maintained while triggering only on signals within the desired channel.

The signal to be measured may be a frequency hopping signal. For measurement purposes, the analyser can be fixed to one channel, rather than requiring means for following the hopping sequence unrelated to the information content of the signal.

The down converter may comprise two stages leading to the intermediate frequency signal to be filtered. The first IF stage may use a fixed frequency local oscillator, while the second is variable to allow turning to a desired channel.

The signal down converter may be arranged to use an asynchronous local oscillator, although a phase locked loop could be used when appropriate to synchronise with the incoming signal.

The second filter may be arranged to receive said IF signal via the first filter, or independently of the first filter.

The bandwidth of the first filter may be in the order of 10 times the bandwidth of the second filter, say from 5 to 20 times.

The processing means may be arranged to trigger by measuring the RF power level at the output of the second filter over time, and creating a trigger event when a threshold is met. The trigger threshold may be adjustable.

In a preferred embodiment the signal is frequency demodulated before analysis. Different processing will be appropriate, depending on the parameters to be measured.

The invention further provides a method of analysing a multi-channel RF signal comprising the steps of:

down converting the received RF signal to devise our intermediate frequency (IF) signal;

using a first filter to filter out all but a portion of the IF signal, said portion including signals from a desired channel to be measured in the RF signal;

extracting a trigger signal from said IF signal using a second filter having a pass band narrower than and inside the passband of said first filter; and

measuring and indicating parameter of the signal filtered by said first filter, in response to trigger events detected in the trigger signal.

### BRIEF DESCRIPTION OF THE DRAWINGS

Embodiments of the invention will now be described, by way of example only, by reference to the accompanying drawings, in which:

FIG. 1 shows a circuit layout, in basic form, suitable for carrying out the invention with frequency/amplitude diagrams.

FIG. 2 is a 3-dimensional graph of frequency against signal level over time, showing activity on wanted and unwanted channels.

FIG. 3 shows a circuit diagram suitable for triggering on to the wanted channel.

### DETAILED DESCRIPTION OF THE EMBODIMENTS

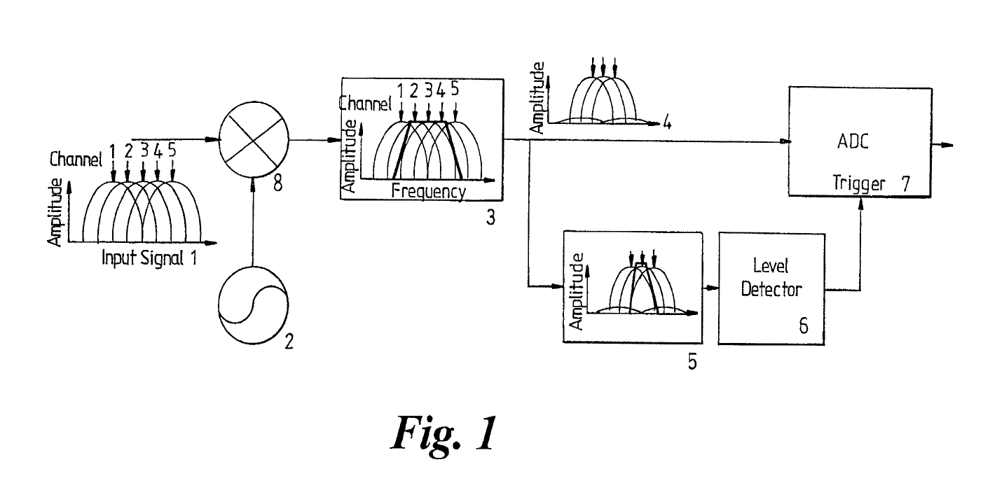

Referring to FIG. 1, a multi-channel RF input signal 1 is first fed into a down converter 8 where it is mixed with the output of a fixed local oscillator 2 to down-convert the frequency of the input signal 1 to a corresponding intermediate frequency. These intermediate frequency (IF) signals will be easier to manage and analyse than ultra-high frequency signals such as Bluetooth signals. In practice the signal will be down converted once with a variable LO frequency and then again with a fixed frequency to provide tuning of the desired frequency to the same intermediate frequency, as is common in commercial spectrum analysers. A single stage is shown in FIG. 1 for simplicity.

This intermediate frequency is then fed into a measurement filter 3 with an adjustable bandwidth between, say, 5 MHz and 1 kHz. A suitable filter for this purpose would be a 4 pole Gaussian filter, or other filter typically provided in a spectrum analyser. The pass band of this filter is wide enough to allow extraction of data content of the signal, for one of the possible channels.

The measurement filter will be centred on the intermediate frequency to be measured (which represents the frequency or channel of interest). When the signal hops to that frequency the analyzer is tuned to, a trigger event will take place. However, the bandwidth of this filter is significantly larger than the bandwidth of any one channel that is to be measured, in order to allow full measurement of the signal parameters. Therefore even the filtered signal 4 will include signal energy from adjacent channels. This makes the measurement signal unsuitable for triggering measurement as the signal level at the output of this measurement filter 3 will be sufficient when the signal is on one of the adjacent channels, to cause false triggers.

In order to ensure accurate measurement at the required frequency, a separate trigger filter 5 is now provided. This trigger filter 5 is inserted between the measurement filter 3 and the conventional trigger circuitry. While a separate spectrum analyser could in principle be used purely to obtain the trigger signal, this would involve duplicating the down conversion and synchronising the centre frequencies of the two analysers to ensure that the signal at the input of both filters is always at the same intermediate frequency.

In the more compact and novel arrangement shown, the same IF signal 4 is fed into the trigger filter 5. This trigger filter 5 has a narrower bandwidth than that of the measurement filter, but fixed on the same centre frequency, such that essentially all of the signal energy on adjacent channels is filtered out. A suitable filter has a bandwidth that is 10% or less of the measurement filter. In the particular example, a 100-300kHz, 2 pole Gaussian filter having a fixed bandwidth to allow accurate level setting, is suitable. The output of the trigger filter 5 consists of a voltage waveform, whose value reaches a peak only if the input signal of the trigger filter 5 is within the RF channel to be measured. The trigger filter 5 need not entirely remove signals from unwanted channels, but provides a much greater difference in the voltage waveform when they are present than can be obtained by the measurement filter alone.

The inplementation of the trigger circuit after the trigger filter 5, includes a level detector 6 which has an arrangement to set a trigger threshold. This threshold value will be based on level of the wanted signal such that unwanted signals produce a voltage output that is below this threshold, therefore not creating a trigger event.

The output of the measurement filter 3 is fed into an analogue to digital converter (ADC) 7, as well as the trigger filter. Depending on the desired measurement, an FM demodulator or other processing circuit (not shown) may be provided at the input to ADC 7. Of course, ADC 7 is part of a digital analyser, and would not be provided in a purely analogue instrument.

The ADC 7 has a trigger pin which is connected to the output of the trigger circuit. This ensures that, providing that the timing delays in the circuit are correctly adjusted, the ADC 7 is only triggered when the trigger threshold value is reached and therefore only when the signal being fed into the ADC 7 is tuned to the channel to be measured

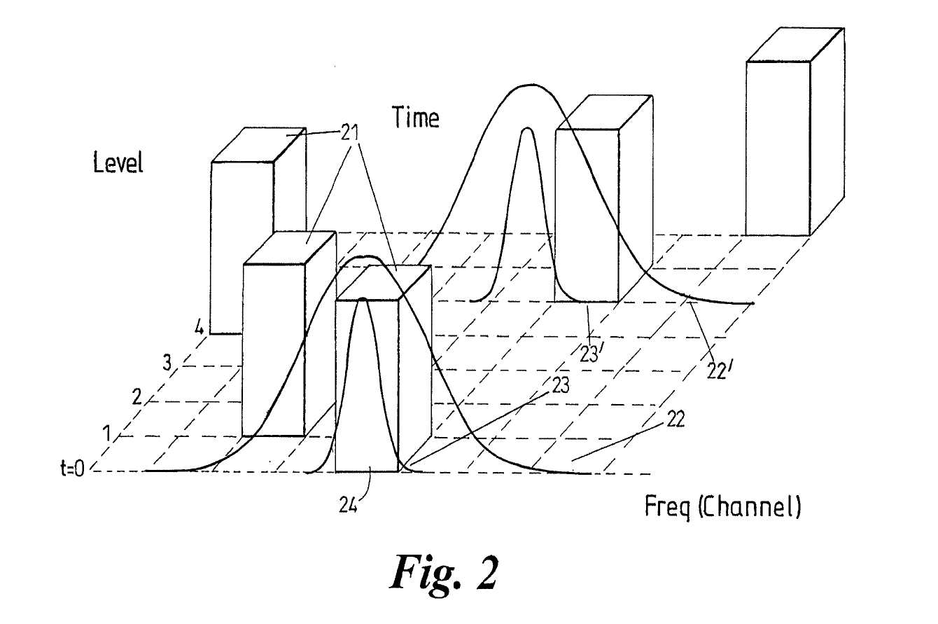

FIG. 2 shows graphically how the trigger circuit works for a frequency-hopped signal. It shows a 3-dimensional graph, with the frequency (channel) on the x-axis, the signal level on the y-axis and time on the z-axis. The frequency hopping is shown by the blocks 21, representing data bursts hopping from channel to channel over time. The measurement filter bandwidth is shown by the curves, 22, 22′ (constant over time). This is centred on the channel of interest at 24 on the x-axis and it can be seen (when t=0) that it is wide enough to include everything on that channel, thus enabling analysis of this signal. However, when the frequency hops to an adjacent channel, such as at t=5, it can be seen that the measurement filter bandwidth (curve, 22′) includes much of this signal. The trigger filter, centred on the same frequency than that of the measurement filter, prevents false triggers that would otherwise occur. This has a much narrower bandwidth (curve 23), which trigger when the signal is on the channel of interest but filters out the majority of the signal when it is on the adjacent channel at t=5 (23′).

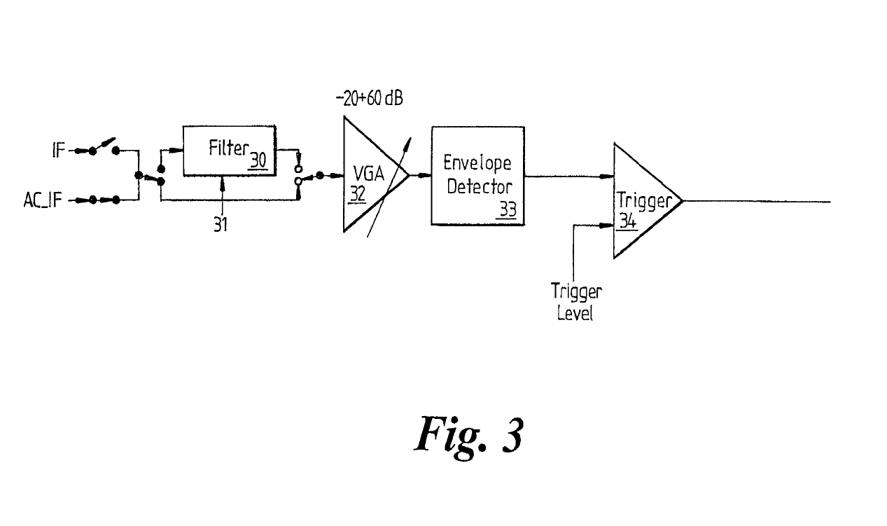

FIG. 3 shows, in more detail, an RF Burst Trigger, suitable for implementing blocks 5 and 6 in the circuit of FIG. 1. The RF burst trigger path can start with either an unfiltered IF or filtered IF signal, according to switch settings Both of these will have been down converted (typically to 21.4 MHz) versions of the signal received at the RF input of the instrument. The filtered IF path, additionally has already been filtered by the measurement filter, and is preferably used when additional frequency selectivity is desired. A 300 kHz bandpass filter 30, the trigger filter (5 in FIG. 1), is selectable when the trigger requires frequency selectivity, but the measurement needs to be wide band, i.e. it is selected when measuring frequency hopped signals according to the method described herein. The filter 30 has a “centre” input 31 which allows the centre frequency of the filter to be easily selected.

The signal then passes through a variable gain amplifier 32 into an envelope detector 33. The envelope detector 33 strips out the (21.4 Mhz) carrier of the input signal keeping only the envelope. This envelope is then fed into the trigger comparator 34 and is compared to a trigger level to actually do the trigger.

The skilled reader will appreciate that circuit such as that FIG. 3 can easily be added to a conventional Spectrum analyser to obtain equipment capable of analysing frequency agile signals in detail. While specific embodiments have been described, many variations and modifications will be envisaged by the skilled person, which do not depart from the spirit and scope of the invention.

1. An analyser for analysing a multi-channel radio frequency (RF) signal wherein said analyser comprises:
a down-converter for deriving an intermediate frequency (IF) signal corresponding to an RF signal to be measured;
a first filter for filtering out all but a portion of the IF signal, said portion including signals from a desired channel to be measured and at least a portion of a neighbouring channel;
a second filter also responsive to the same IF signal and having a pass band narrower than and inside the pass band of said first filter;
processing means for measuring and indicating at least one parameter of the signal filtered by said first filter in response to a trigger signal filtered by said second filter.

2. An analyser as claimed in claim 1 wherein the signal to be measured is a frequency hopping signal.

3. An analyser as claimed in claim 2 wherein, for measurement purposes, said analyser is fixed to one channel.

4. An analyser as claimed in claim 1 wherein the down converter comprises two stages leading to the intermediate frequency signal to be filtered.

5. An analyser as claimed in claim 4 wherein the first IF stage may use a variable frequency local oscillator to allow tuning to a desired channel, while the second is fixed.

6. An analyser as claimed in claim 1 wherein the signal down converter is arranged to use an asynchronous local oscillator.

7. An analyser as claimed in claim 1 wherein the signal down converter is arranged to use a phase locked loop.

8. An analyser as claimed in claim 1 wherein the second filter is arranged to receive said IF signal via the first filter.

9. An analyser as claimed in claim 1 wherein the second filter is arranged to receive said IF signal independently of the first filter.

10. An analyser as claimed in claim 1 wherein the bandwidth of the first filter is in t he order of 10 times the bandwidth of the second filter.

11. An analyser as claimed in claim 1 wherein the processing means are arranged to trigger by measuring the RF power level at the output of the second filter over time, said processing means creating a trigger event when a threshold is met.

12. An analyser as claimed in claim 11 wherein the trigger threshold is adjustable.

13. An analyser as claimed in claim 1 wherein the signal is frequency demodulated before analysis.

14. A method of analysing a multi-channel RF signal comprising the steps of:
down converting the received RF signal to derive an intermediate frequency (IF) signal;
using a first filter to filter out all but a portion of the IF signal, said portion including signals from a desired channel to be measured in the RF signal;
extracting a trigger signal from said IF signal using a second filter having a pass band narrower than and inside the pass band of said first filter; and
measuring and indicating at least one parameter of the signal filtered by said first filter, in response to trigger events detected in the trigger signal.

15. A method as claimed in claim 14 wherein the signal to be measured is a frequency hopping signal.

16. A method as claimed in claim 15 wherein, for measurement purposes, only one channel is analysed.

17. A method as claimed in claim 14 wherein the RF signal is down converted in two stages leading to the intermediate frequency signal to be filtered.

18. A method as claimed in claim 17 wherein the first IF stage may use a variable frequency local oscillator to allow tuning to a desired channel, while the second is fixed.

19. A method as claimed in claim 14 wherein the signal down conversion is achieved by using an asynchronous local oscillator

20. A method as claimed in claim 14 wherein the signal down conversion is achieved by using a phase locked loop.

21. A method as claimed in claim 14 wherein the second filter is arranged to receive said IF signal via the first filter.

22. A method as claimed in claim 14 wherein the second filter is arranged to receive said IF signal independently of the first filter.

23. A method as claimed in claim 14 wherein the bandwidth of the first filter is in the order of 10 times the bandwidth of the second filter.

24. A method as claimed in claim 14 wherein trigger signal is achieved by measuring the RF power level at the output of the second filter over time, creating a trigger event when a threshold is met.

25. A method as claimed in claim 24 wherein the trigger threshold is adjustable.

26. A method as claimed in claim 14 wherein the signal is frequency demodulated before analysis.
